(19) United States
(12) Patent Application Publication
(10) Pub. No.: US 2014/0372442 A1
(43) Pub. Date: Dec. 18, 2014

(54) K-GRID FOR CLUSTERING DATA OBJECTS

(71) Applicant: Venor, Inc., Mountain View, CA (US)

(72) Inventors: Rudi CILIBRASI, San Jose, CA (US); Wenfeng Wang, Mountain View, CA (US); Ali Golshan, Los Altos, CA (US)

(73) Assignee: Venor, Inc., Mountain View, CA (US)

(21) Appl. No.: 14/214,932

(22) Filed: Mar. 15, 2014

Related U.S. Application Data
(60) Provisional application No. 61/794,334, filed on Mar. 15, 2013.

(51) Int. Cl. G06F 17/30

(52) U.S. Cl. CPC G06F 17/30598
USPC 707/737

(57) ABSTRACT

Algorithms and systems for clustering information objects. Objects including metadata may be populated within a k-dimensional grid (K-Grid). A distance function between objects may be calculated, and a cost function may be calculated. Optimization may occur over several iterations by applying random mutation operations on the K-Grid and re-calculation of the cost function.

### CROSS-REFERENCE TO RELATED APPLICATION

This application claims priority to U.S. Provisional Application No. 61/794,334, entitled “K-Grid for Data Visualization and Data Mining,” filed 15 Mar. 2013, the entire disclosure of which is hereby incorporated by reference.

### TECHNICAL FIELD

This application relates to the fields of data analysis and computation.

### BACKGROUND

Data visualization and data mining seek to address the question of how we might find patterns in data without humans first forming specific hypotheses for testing.

Typically, data mining may involve the automatic or semi-automatic analysis of large quantities of data to extract previously unknown interesting patterns. Examples of such patterns may include groups of data records (cluster analysis), unusual records (anomaly detection) and dependencies (association rule mining). This may involve using database techniques such as spatial indices. These patterns can then be interpreted as a kind of summary of the input data, and may be used in further analysis or, for example, in machine learning and predictive analytics. For example, the data mining step might identify multiple groups in the data, which can then be used to obtain more accurate prediction results by a decision support system.

Data mining may, for example, use automatic machine learning and high-speed computers to make machines do the hard work of generating testable hypotheses as well as the statistical calculations required to test each of them. By iterating over very many interesting hypotheses, some may be found that are accurate and useful via automatic statistical significance testing given a suitable probability model. When these hypotheses range over topological spaces and utilize information theory as the basis for the model, the approach is called information topology.

There are many techniques for data mining and for the visualization and analysis of such mined data. One example of interpreting such data involves the formation of affinities between information objects. Thus, it is useful to have methods for clustering information objects based on such related information as meta-data.

One may imagine a set of objects each of which is described by a data structure containing metadata of various types. Type of objects could be anything: for example, real work items such as cars, houses, nations, furniture, food, restaurants, politicians, planets, or animals, etc. The objects could be electronic: for example, articles, tweets, web pages, PDF files, etc. They could also be abstract: for example, concepts, theories, beliefs, policy questions, etc. The meta data could be in the form of any data type: for example, strings, integers, real numbers, pictures, videos, or simple binary blocks. Each group of objects may also have conceptual types: for example, equations, URLs, DNA sequences, authors, book titles, etc.

There is often a need for an observer to determine which of these items are closest to each other, that is, how they cluster together. Further imagine that the observer also wants to determine which of the objects are of closest interest to the observer. The observer is also characterized by a large amount of metadata, also of very diverse data types and conceptual types. To cluster the objects together and to cluster them as to how they relate to the observer is a very complex process given the large amount of metadata in both the objects and the observer

Different sets of objects can have very large differences in the quantity of metadata and the types of metadata present. Also while the schema for the metadata for the observer is the same for all of the observers (at a given time), the metadata for each observer may be populated in a very sparse manner. So although the observer metadata schema may be the same from one observer to the other the high degree of sparseness can effectively means that each observer's metadata is actually quite unique as to structure, and, of course is unique as to the values of metadata present in that structure.

There is a need for a solution to this problem that can handle: the large and complex metadata of each object, a high degree of diversity of metadata between objects (including sparseness), a large number of objects which are desired to be clustered relative to one another and relative to the user, and the sparseness of the observer metadata. Thus, the solution has to be extremely flexible or “general” across extremely diverse data sets.

### BRIEF SUMMARY

Described herein are embodiments including a method for making a special-purpose digital computer system by storing an executable application program in a memory of a general purpose digital computer system, and executing the stored program to impart to the general purpose computer system the functionality of clustering together information objects having metatata, by changing the state of a one or more processors within the computer system when program instructions are executed, wherein the program instructions comprise: (a) creating a k-dimensional grid structure; (b) populating at least some of the nodes of the k-dimensional grid structure with the objects, organized according to arrangement 0; (c) solving a cost function C₀ for the objects at the nodes of the k-dimensional grid; (d) rearranging the objects within the k-dimensional grid, such that they are organized according to arrangement 1; (e) re-computing the cost function C₁ based on the rearranged objects; and (f) repeating steps (d) and (e) some number of times n≧0; wherein cost function Cₙ₊₁ is lower than C₀.

In various embodiments, the cost function C may be defined as:

$$C = {\sum }_{r ∈ U} c ( r ) w ( r )$$

where r is a location within the k-dimensional grid, U is the set of all locations within the k-dimensional grid, c(r) is a local cost function for each location r, and w(r) is a weighting function for each location r which may be a constant 1. It also may be defined as

$$w ( p ) = {\sum }_{i = 1}^{k} \frac{( a + {p}_{i} ) ( i + b ) ( i + c )}{abc}$$

where pᵢ is the i-th coordinate of p., where a, b, and c are constants.

In further embodiments, c(p) may be defined as:

$$c ( p ) = {( {\sum }_{q ∈ L ( p )} \frac{{d ( {A}^{- 1} ( q ) , {A}^{- 1} ( p ) )}^{γ}}{‖ q - p ‖} )}^{1 / γ}$$

where q is a location within the k-dimensional grid, L(p) is a local neighborhood of a point p, A⁻¹ is an assignment function mapping a position on the k-dimensional grid to a set of metadata associated with an information object, d(x,y) is a distance function between metadata sets x and y, each of x and y being associated with objects assigned to locations on the k-dimensional grid, and wherein γ is an arbitrary positive parameter.

The distance function wherein d(x,y) may be, in various embodiments, the Normalized Compression Distance, the Normalized Web Distance, or some combination of the two.

Various additional embodiments, including additions and modifications to the above embodiments, are described herein or would be apparent to a person working in this field.

### BRIEF DESCRIPTION OF THE DRAWINGS

The accompanying drawings, which are incorporated into this specification, illustrate one or more exemplary embodiments of the inventions disclosed herein and, together with the detailed description, serve to explain the principles and exemplary implementations of these inventions. One of skill in the art will understand that the drawings are illustrative only, and that what is depicted therein may be adapted, based on this disclosure, in view of the common knowledge within this field.

In the drawings:

FIG. 1 is a diagram illustrating a one dimensional local neighborhood showing two neighbors, one unit distant from a central node.

FIG. 2 is a diagram illustrating a one dimensional K-Grid with seven nodes.

FIG. 3 is a diagram illustrating a two dimensional local neighborhood showing eight neighborhoods, 1 or (\sqrt{2}) unit distant from a central node.

FIG. 4 is a diagram illustrating a wrapped K-Grid of one dimension. The first and last items are connected in this example with one unit distance.

FIG. 5 is a diagram illustrating a simple unit (minimum) length swap in a one-dimensional K-Grid.

FIG. 6 is a diagram illustrating a one dimensional K-Grid with a specific assignment in the upper row. The next row shows the assignment after a two-length-segment swap mutation.

FIG. 7 is a diagram illustrating an optimal (lowest cost) arrangement after many iterations, which is in this example a sorted list.

FIG. 8 is a diagram illustrating a comparison of unwrapped (top) and wrapped (bottom) K-Grids. In the wrapped K-Grid, the first and last items are connected, so that the total cost is 24 for both top and bottom arrangements in case of an example calculation in which γ=1. If γ=2, the cost in this example calculation will be 17 (top) and 15.3 (bottom).

FIG. 9 is a diagram illustrating a 4×5 two-dimensional K-Grid wrapping, with a torus topology.

FIG. 10 is a diagram illustrating an example two-dimensional K-Grid with high cost, showing animals placed randomly.

FIG. 11 is a diagram illustrating an example two-dimensional sorted K-Grid.

FIG. 12 is a diagram illustrating a 4-unit 2-level one dimensional hierarchical K-Grid.

### DETAILED DESCRIPTION

An algorithm called K-Grid for clustering data objects is described which may be useful for data visualization as an assignment optimization procedure with wide applicability. In one embodiment, K-Grid may take as input a list of object labels and an associated distance matrix. K-Grid may search to find an optimal objective score for a specific assignment of objects to placements over a lattice of points with integer coordinates. An example is described using a hill-climbing heuristic to optimize the permutation search for information theoretic objective functions to allow for larger-scale data-mining applications.

Imagine a set of objects as follows: Each may have a name and a data structure defining the set of metadata for each object. The structure of the metadata is in one embodiment the same for all objects in the set though of course the values of metadata may be different from object to object. In another embodiment, there may be different, or very different metadata structures, both in type and quantity. For example, a group of car objects, each of which has a metadata structure with 10 strings, followed by 5 real numbers, may be clustered with a set of dog objects whose metadata has 5 strings, 10 real numbers, and 3 integers. In many embodiments, the population of the metadata from one object to another in the set may be sparse. So, for example, if the objects were species of dogs, the data structure for each dog might have the species name and perhaps metadata for: typical weight, max weight, least weight, list of hair colors, information on temperament (good with kids), special skills (good watch dog, good at fetching, learns easily), and many other items, but for some of the dog items, some of this metadata might be blank or empty.

Also imagine an observer for whom one wishes to present a subset of the objects such that objects are presented to that observer in the order of maximum interest to that observer. Because the nature of any of the objects may not be known, one may first want to cluster them into related groups. Doing so by inspecting the metadata of each object may be prohibitively expensive and may require an algorithm that was different for different types of objects (e.g., one may need a dog species classifier, a horse species classifier, a galaxy classifier, or an automobile model classifier). The inventions disclosed herein describe processes for automating the clustering of objects, which in one embodiment is independent of type of object.

As an overview, various embodiments described herein include the following:
Matrices or “grids” having “k” dimensions, which may serve as a framework for holding objects that are being clustered.
Cost functions that may evaluate the distance between any two objects that are adjacent to one another or which are otherwise associated with one another in the grid. This cost function may determine how similar the two adjacent or corresponding objects are by evaluating the metadata of each object.
Processes that may evaluate the cost function for every object in the grid relative to each of the objects to which it is adjacent and then may sum up all of these costs across all objects in the grid. This overall sum may form a basis for determining the overall “close-ness” of all of the objects in the grid. The lower this sum of distances between all objects and their immediate neighbors, the better clustered the objects in the grid can be considered.
Algorithms that evaluate a grid for the sum of distances, then randomly “scramble” the positions of all of the objects within the grid and evaluate them again as described above. If the new random locations yield a lower overall “closeness” (sum of distances), then the new version of the K-Grid may be assumed to be a better clustering of the objects then the previous one and the newer version is retained. If the newer closeness is higher (meaning the new positions within the K-Grid are “less close” than the prior K-Grid assignments then the new K-Grid may be discarded and the old one retained. The cycle then may repeat with a new random assignment of objects to grid points and another evaluation of closeness of adjacent points.
Through this process the system may iterate toward a clustering of objects within the K-Grid that may be based on the similarity of the objects.

Various example embodiments of the present inventions are described herein. Those of ordinary skill in the art will understand that the following detailed description is illustrative only and is not intended to be in any way limiting. Other embodiments of the present inventions will readily suggest themselves to such skilled persons having the benefit of this disclosure, in light of what is known in the relevant arts, the provision and operation of information systems for such use, and other related areas.

Not all of the routine features of the exemplary implementations described herein are shown and described. In the development of any such actual implementation, numerous implementation-specific decisions must be made in order to achieve the specific goals of the developer, and that these specific goals will vary from one implementation to another and from one developer to another. Moreover, such a developmental effort might be complex and time-consuming, but would nevertheless be a routine undertaking of engineering for those of ordinary skill in the art having the benefit of this disclosure.

Throughout the present disclosure, relevant terms are to be understood consistently with their typical meanings established in the relevant art.

In addition, [symbol] may be written to represent the set of all integers, and [symbol] ₊ to represent the positive integers. Similarly, [symbol] ₛ may be understood to represent the integers taken modulo s. Vectors may be written in bold typeface so that b may be understood to be a vector with individual components written as bᵢ with iε [symbol] + and i≦d when b has dimension d. The norm ∥b∥ may be written to denote the Euclidean norm of b so that

$$‖ b ‖ = \sqrt{{\sum }_{i = 1}^{d} {b}_{i}^{2}} \qquad Eq . 1$$

When |x| is written, it may denote that x is a real number or a set. If x is a set then |x| may refer to the cardinality of the set. If x is a real number, then |x| may denote the absolute value of x.

The term K-Grid may refer to a k-dimensional grid according to the present disclosure. In one embodiment, a K-Grid may take as input a set of parameters that define its shape. One of these is kε [symbol] +. This may be referred to as the dimension of the K-Grid. k may also be the dimension of another parameter s, which may be called the size of the K-Grid. In one embodiment, sᵢε [symbol] and sᵢ>3. Each location (or point) in a K-Grid may be addressed via a k-dimensional coordinate of the form

$${\prod }_{i = 1}^{k} {ℤ}_{{s}_{i}} \qquad Eq . 2$$

U may be written to represent the union of all possible locations in a K-Grid.

A local neighborhood may be defined for a point p (written L(p)) in a K-Grid. This local neighborhood may be any point q in the K-Grid such that

0<∥p−q∥≦\sqrt{K} Eq. 3

Similarly, a near neighborhood may be defined as a group of grid elements that are immediately adjacent to an object in the grid.

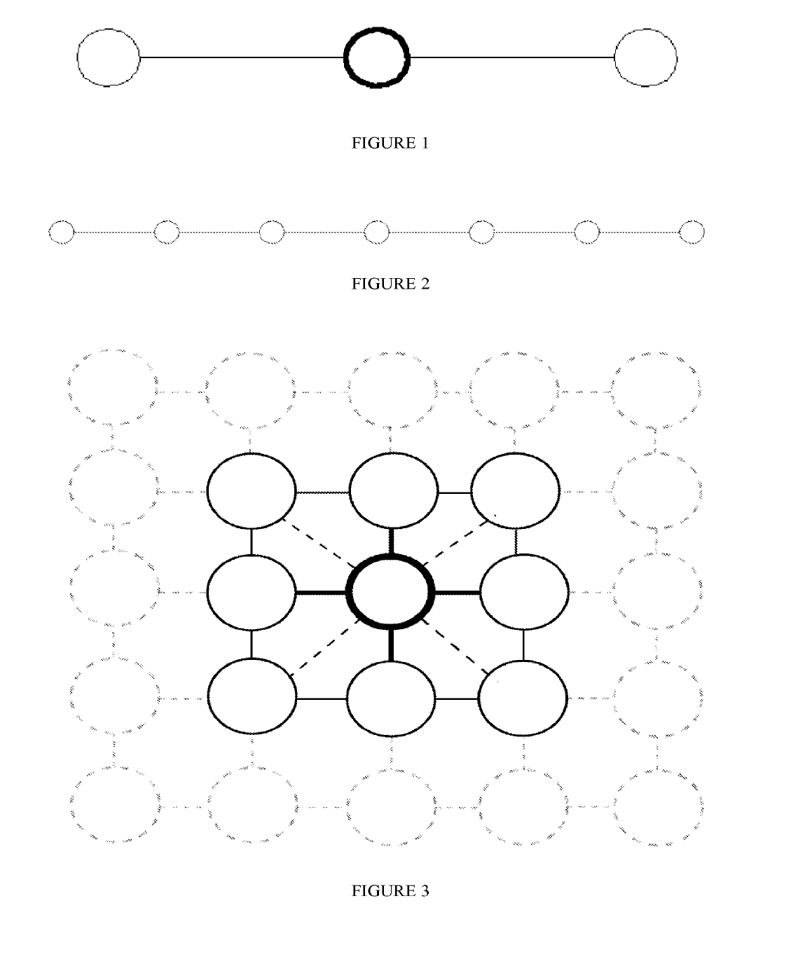

Two categories of K-Grid may be distinguished, called wrapped K-Grid and non-wrapped K-Grid. A non-wrapped K-Grid may be associated with a grid distance measurement equivalent to normal Euclidean spatial distance. A simple example of a non-wrapped K-Grid may be seen in FIG. 1, which shows a one-dimensional, non-wrapped K-Grid with three nodes. FIG. 2 shows a one dimensional K-Grid with seven nodes. FIG. 3 shows a two-dimensional K-Grid with 25 nodes.

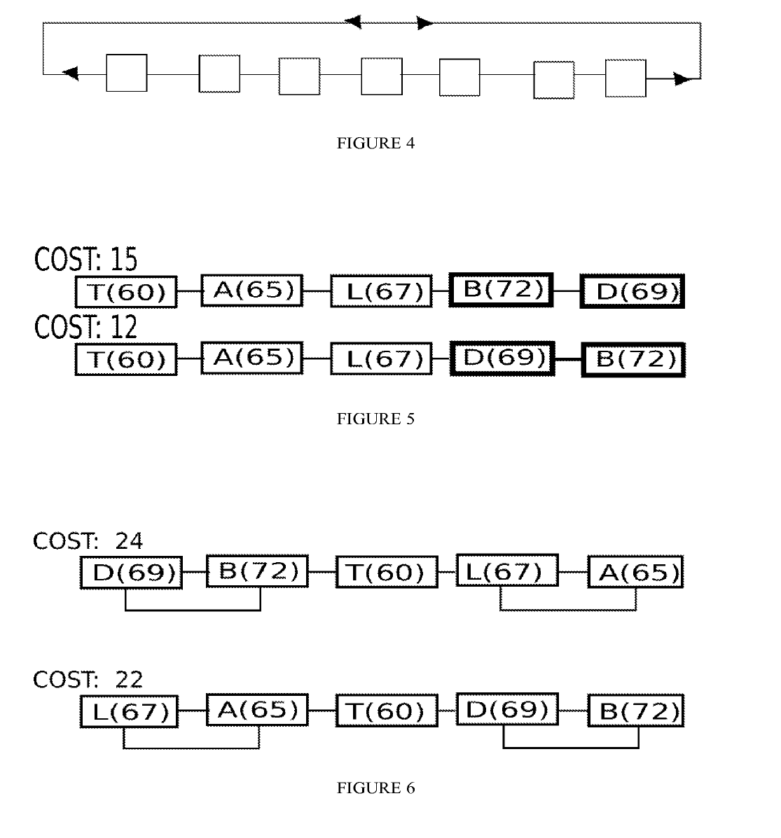

In a wrapped K-Grid, the coordinates may be taken modulo sᵢ. The edges may be considered to “wrap around” from one side to another with distance one. FIG. 4 illustrates an example one-dimensional wrapped K-Grid with seven nodes, each node being a distance of one unit from its neighbors. In some non-wrapped embodiments, the outermost grid points may be “disadvantage,” because unlike the inner points, they only have one neighbor. In a wrapped grid such as this one, each node actually has two neighbors, regardless of its location. As a result of the wrapping, the left-most position in this one-dimensional K-Grid is just one grid distance away from the right-most position. Topologically, this K-Grid has the shape of a ring or circle.

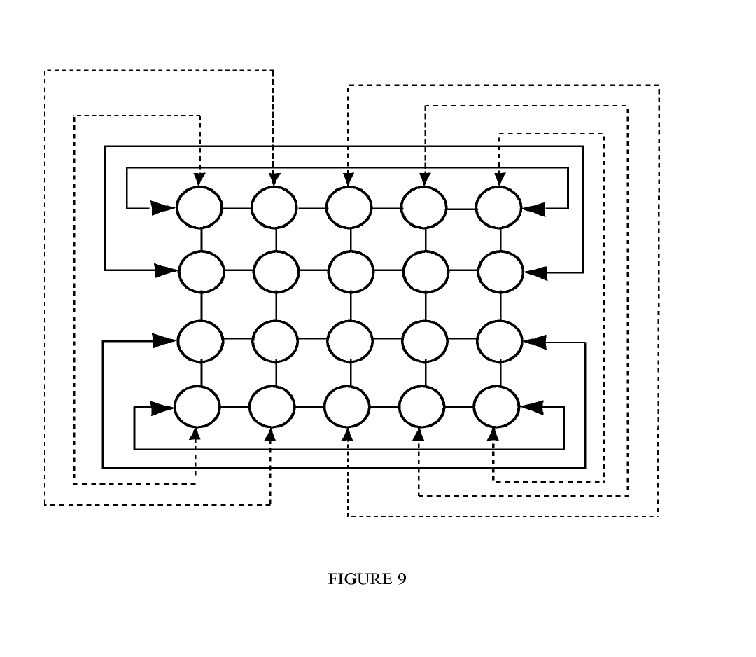

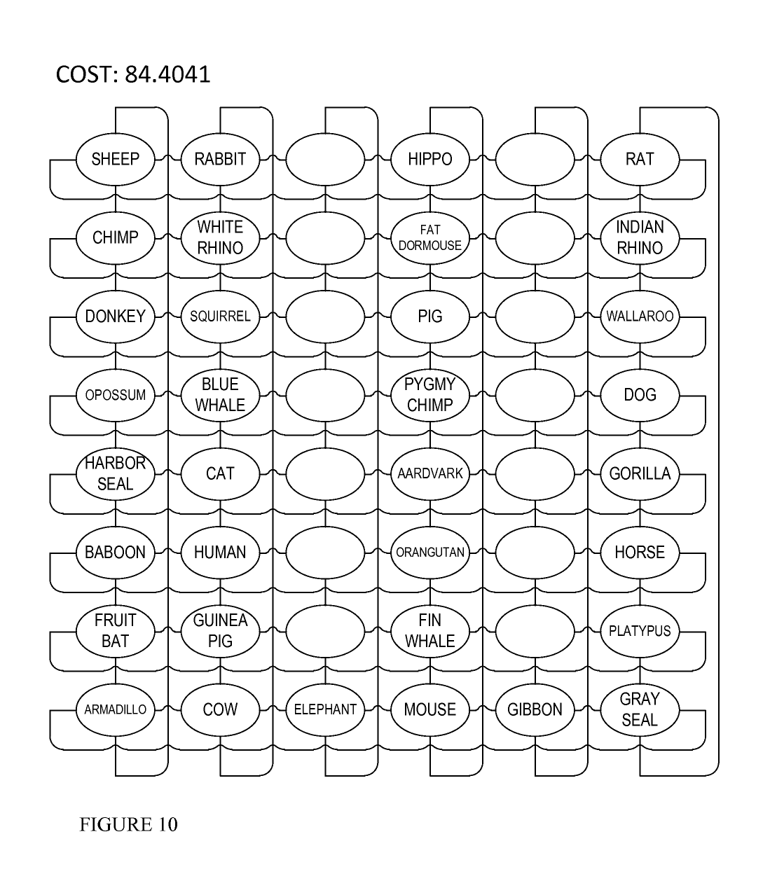

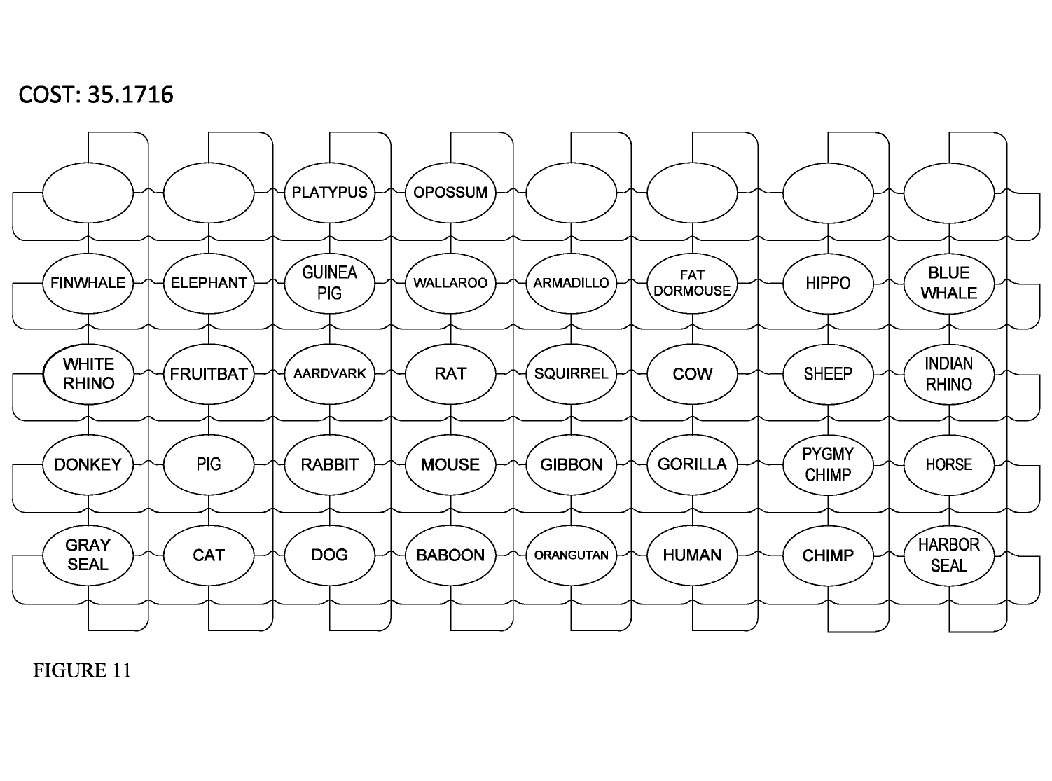

FIG. 9 illustrates an example 4×5 two-dimensional wrapped K-Grid wrapping. This figure depicts how the outer edges of a two-dimensional K-Grid may be interconnected when it is wrapped. As shown by the dark lines, objects in the right-most column are “connected” to the objects in the left-most column. “Connected” in this sense means that the grid considers the nodes to be adjacent for the purposes of invoking a distance function or in otherwise calculating distances. Likewise, the dashed lines show corresponding “connections” between objects in grid positions along the bottom row of the grid to objects on the top row. If both dimensions are so wrapped, the resulting K-Grid will have a topology that could be thought of as a torus.

In an alternative embodiment, a two-dimensional K-Grid may be wrapped in only one dimension, resulting in a ring shape, or a topological sphere with two boundaries. Higher dimensional K-Grids may be wrapped in all, or only some, of the directions, resulting in various topological arrangements.

In the case of a K-Grid wrapped in all directions, this means that all points may have an equal number of neighbors at each distance in the wrapped K-Grid. This is in contrast to the non-wrapped K-Grid whose corner, edge, and face locations may have fewer neighbors than more central points may have. As a consequence, non-wrapped K-Grids may have a variety of different local neighborhood shapes, whereas wrapped K-Grids may in one embodiment have a single common shape for all local neighborhoods centered around each point. The lack of boundaries and additional uniformity may be advantageous in the use of K-Grids for clustering information objects.

In a wrapped K-Grid the local neighborhood L(p) may be characterized as |L(p)|=3^{k}−1. The local neighborhood of a non-wrapped K-Grid may be characterized by k≦|L(p)|≦3^{k}−1. Table 1 shows example calculations for local neighborhood and distances for K-Grids of up to five dimensions. Distances for higher dimensional K-Grids may be calculated according to the same pattern, based on the known geometries of k-dimensional hypercubes.

TABLE 1
Example distance calculations for neighborhood node,
enumerating distances for k-dimensional K-Grids in
which k ranges from 1 to 5. Distances for K-Grids
of other dimensions may be calculated similarly.

| k | \sqrt{k} | \|L(p)\| = 3^{k} − 1 | Enumeration of distances [distance, count] |
|---|---|---|---|
| 1 | 1 | 2 | [1, 2] |
| 2 | \sqrt{2} | 8 | [1, 4], [\sqrt{2}, 4] |
| 3 | \sqrt{3} | 26 | [1, 6], [\sqrt{2}, 12], [\sqrt{3}, 8] |
| 4 | \sqrt{4} | 80 | [1, 8], [\sqrt{2}, 24], [\sqrt{3}, 32], [\sqrt{4}, 16] |
| 5 | \sqrt{5} | 242 | [1, 10], [\sqrt{2}, 40], [\sqrt{3}, 80], [\sqrt{4}, 80], [\sqrt{5}, 32] |

FIG. 3, which shows a two-dimensional K-Grid with 25 grid points, illustrates the concept of a K-Grid “neighbor” which in this example may be specified as the nodes in the K-Grid that are immediately adjacent. If the bold object at the central grid point is the object under consideration, its “neighbors” for the purposes of K-Grid calculations can in one embodiment be specified as the eight grid points around it. In this example, the grid distance to the points that are straight up, straight down, and to the immediate right and left is taken to be 1. The grid distance to the upper left, upper right, lower left, and lower right nodes is taken to be \sqrt{2}, because because the length, L, of a 45 degree diagonal is L=\sqrt{x²+y²} and in this case x and y are 1, so the distance to those “corner” points is \sqrt{1²+1²}=\sqrt{2}.

For either wrapped or non-wrapped K-Grids, the total number of places (i.e., distinct coordinate locations) or discrete volume V in the K-Grid may be calculated as the product of components s, of the size vector s:

$$V = {\prod }_{i = 1}^{k} {s}_{i} \qquad Eq . 4$$

### Associating K-Grids with Information Objects

A K-Grid may be associated with information objects in a number of different ways. In one embodiment, a group F of files, strings, or in general objects may be given as input to the K-Grid, such that |F|≦V. An invertible function A, called an assignment of the group F to the K-Grid, may be defined so that each object in fεF has a specific location A(f). A⁻¹(p) may also be defined, which takes as input any location p and returns the object stored there or the special constant φ meaning empty. In one embodiment, assignment of objects to locations in a K-Grid may be randomized, such as the result of a pseudorandom number generator. If some degree of clustering is already known, the objects can in another embodiment be pre-structured. In one embodiment, there is a certain percentage of K-Grid nodes that are empty. As discussed below, some amount of sparseness within a K-Grid can improve performance.

A domain-specific distance function, not to be confused with the grid distance, may be defined, in one embodiment, as a matrix d(x,y) whose arguments are indexes for objects in F. This distance function, in one embodiment, may return a nonnegative real number in all cases. In other embodiments the distance function may return integers or other number sets.

Any suitable distance function may be used. For example, the distance function may defined as the Normalized Compression Distance (NCD) via data compression. Given two data blocks of arbitrary length, NCD may return a scalar indicating how close the two blocks are to each other in an information-theoretic sense. If the two objects are identical, the scalar would be 0, whereas if the two objects are totally different, the scalar would in some embodiments be 1. NCD is an information distance that may be calculated in various ways known in the art, all of which may be applicable to use in association with a K-Grid. For example, an NCD based on some arbitrary compressor Z may be calculated as follows:

$$N C {D}_{Z} ( x , y ) = \frac{Z ( xy ) - min \{ Z ( x ) , Z ( y ) \}}{max \{ Z ( x ) , Z ( y ) \}} \qquad Eq . 5$$

Where Z(x) is the binary length of object x compressed with compressor Z. NCD has a number of different modes and can utilize any normal data compression algorithm. Many compressors Z are known in the art, including LZW, DEFLATE, gzip, bzip2, and PPMZ algorithms, and many more will continue to be developed over time. Compressors may also be designed to specially compress particular types of objects, such as hypertext, video, images, or audio. Compressors may be either lossy or lossless, and all of the above may be used to calculate a meaningful information distance for use with a K-Grid. One example is the use of zlib, a data compressor similar to gzip.

Another example of a distance function is the Normalized Web Distance (NWD), which may in one embodiment be used for natural language processing. An application of NWD is described in Cilibrasi R. & Vitanyi P., “Normalized Web Distance and Word Similarity,” in Handbook of Natural Language Processing (2d ed.), eds. Indurkhya N. & Damerau F. J., CRC Press 2010, ISBN 978-1420085921.

In one embodiment, a choice between NCD and NWD, or between other distance functions, may be made on the basis of analyzing the end-points of various K-Grid optimizations using similar objects and/or similar meta-data, separately using the different distance functions, and determining which end-points are most optimal or efficient.

In another embodiment, a distance function may be used as illustrated in FIG. 5 and described below, in which each object is assigned a cost value, and the distance function is defined as the absolute value of the distance between each object cost value.

Because there are only a finite number of objects in F, there are only finitely many sample points possible for a distance function, and these may be understood in one embodiment as the upper- or lower-triangular half of a distance matrix.

Each object in F can be associated with a label that can be used to represent the object when rendering the K-Grid. This label might in various embodiments be a word, number, or image that in some way represents the contents of the object (e.g., the file or string) at a high level.

### Scoring K-Grids Based on Global Cost Objective Functions

A given K-Grid may be scored in various ways, to reflect a given outcome in analyzing or manipulating the data. For example, the K-Grid may be scored using a function that measures the aggregate distances between elements of the K-Grid, as calculated from a distance function. In one embodiment, a global cost or benefit function may be used for such scoring, over all assignments of the group F via an aggregate weighted sum of costs over all local neighborhoods.

For example if there is an assignment A for the set of objects F in the K-Grid, then a local cost c(p) may be defined, in one embodiment, as

$$c ( p ) = {( {\sum }_{q ∈ L ( p )} \frac{{d ( {A}^{- 1} ( q ) , {A}^{- 1} ( p ) )}^{γ}}{‖ q - p ‖} )}^{1 / γ} \qquad Eq . 6$$

where γ is a parameter that may take any positive value. For example, γ may in one embodiment be 2. In other embodiments, it may be 1, 1.5, 3, 4, or other positive values. Using γ=1 has the advantage of being easier to understand and calculate. It corresponds to a linear sum corresponding to the minimum cost. Using γ=2 reflects a quadratic sum, corresponding to second order moments, related to a standard deviation. It minimizes the influence of standard deviation on the error in the calculated cost equation.

The distance function d may in one embodiment be extended to include an arbitrary distance from each object to an empty space as well as an arbitrary distance between empty spaces. In several embodiments, these distances may be very high, or very low or zero, or the distances between empty space may be very high while the distance between each object and empty space may be very low, or vice versa. These structural constants can determine the phase behavior of the system as explained below.

An example aggregate weighted sum C may in one embodiment be calculated as the sum of the local cost function (overall objective function) over all locations in the K-Grid:

$$C = {\sum }_{r ∈ U} c ( r ) w ( r ) \qquad Eq . 7$$

The function w may be used to represent an arbitrary location-dependent weighting function. It is possible to use any positive constant for this number. However, doing so may in some use-cases cause inconvenient symmetries. Therefore, in one embodiment, a non-constant nonisotropic weighting function may be used to normalize orientation as described below. Weightings may in another embodiment also be based on prior analysis of the same or similar information objects.

For example, if the information objects associated with the K-Grid are metadata relating to a particular person, a weighting function may be based on optimization specific to that person. Such optimization may, for example, be the result of machine learning operations on other meta-data or online behavior.

### K-Grid Mutation Operations

In a given K-Grid, a block may be defined as a given range of locations. For example, in one dimension, a block may be a range of locations described using a lower and upper bound. In two dimensions, a block may be a rectangle, and in higher dimensions, a block may be selected that forms a complete non-empty rectilinear grid within a potentially larger K-Grid. A non-overlapping pair of blocks may be characterized within a K-Grid as two blocks with equal dimensions and orientation that do not have any locations in common. A block-swap operation may, in one embodiment, be characterized on an assignment A as a transposition of all points from one block to the other for a non-overlapping pair of blocks. In another embodiment, a block swap operation may allow a single bit of freedom per dimension to indicate if items are copied in forward or reversed (reflected) direction. Other degrees of freedom may be added, or substituted. For example, items may be rotated or otherwise permuted according to some pattern.

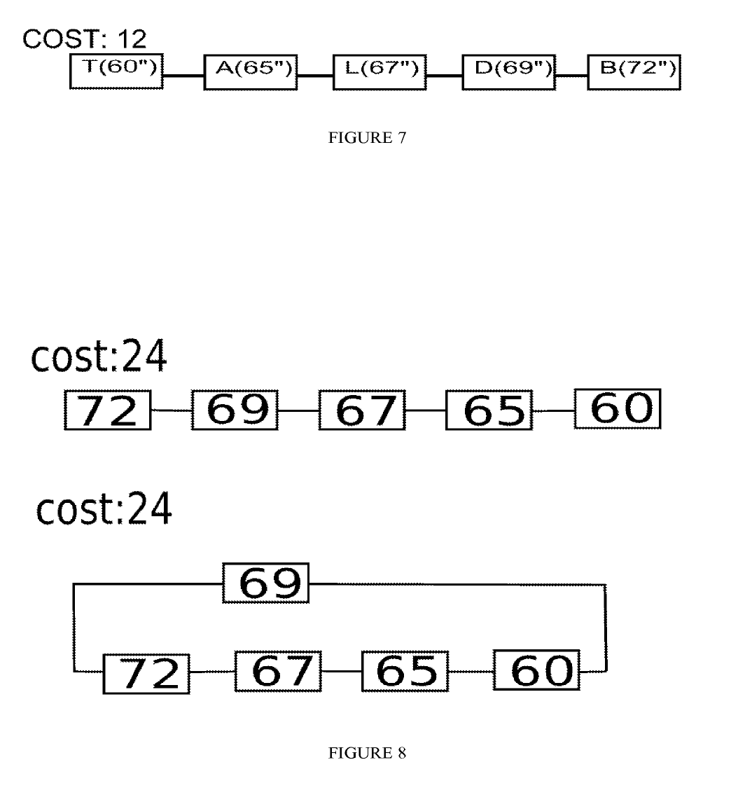

In one embodiment, a random or pseudo-random number generator may be used to select a non-overlapping pair of blocks to create a simple mutation operation that transforms assignment A into a different assignment A′ as illustrated for example in FIG. 5. This figure illustrates two iterations of object positioning in a one-dimensional, non-wrapped K-grid and how the overall objective function for the K-Grid may change as objects in the grid are mutated (scrambled) after each cycle of a K-Grid mutation algorithm, such as the K-Grid greedy search heuristic algorithm discussed below. In this figure, the notation in each K-Grid location X(C) means the object having name “X” whose metadata evaluates to a cost of C. In this embodiment, the distance function is characterized as the absolute value of the difference between the object cost C, for each object. The distance function in this embodiment contrasts with the NCD distance function, in that NCD would not assign a cost to each node, but would only look at the costs pairwise. In other words, it would compare the metadata of two cells to see their distance. The absolute values of cost shown into each cell in FIG. 5, FIG. 6, FIG. 7, and FIG. 8 are provided for illustration purposes.

The metadata costing is, in various embodiments, a measure of similarity of objects and may be derived from the metadata of the objects. (The metadata itself is not shown in FIG. 5, but any arbitrary metadata may be used if there is a defined distance function between the objects, based on the metadata.) In the upper representation of the K-Grid of FIG. 5, the juxtaposition of object B and L is not optimal because B and L have a relatively long distance between each other, that distance being 72−67=5. Therefore, one would expect that multiple iterations of the K-Grid algorithm may cause B to move to the right of the grid.

In the first (upper) representation, the “COST” of 15 is the value that the objective function would return. In this embodiment, this is equal to the sum of the distance between each of the objects in the grid. The value 15 is the result of the sum (moving left to right on the grid) of |65−60|+|67−65|+|72−67|+|69−72|.

In the second iteration, objects D and B are swapped. Intuitively, this is a better clustering result because the two cells with higher cost, D and B, are now adjacent, thereby minimizing the distance between them. Moreover, two objects with more similar cost, L and D, are also now adjacent, also minimizing the distance between them. This results in the lower COST of 12, which is simply |65−60|+|67−65|+|69−67|+|72−69|. This illustrates how the application of the distances and objective function which sums up those distance, together with random mutation of the cells in the K-Grid, may “discover” better clustering. If, in a different embodiment, this K-Grid were wrapped, a different outcome would likely result, given that the T object would now be adjacent to the objects of interest.

A complex mutation may be characterized, in one embodiment, according to the following pseudocode:

```
begin loop:
    apply simple mutation.
    toss fair coin.
    if heads,
        repeat loop.
    if tails,
        end loop.
```

This complex mutation algorithm indicates that instead of just scrambling the K-Grid once before each evaluation of distances, the mutation repeats some number of times before each evaluation, with some percentage (e.g., 50%) chance after each mutation that the mutations will stop at that point.

### K-Grid Search Heuristics

In one embodiment, a space of K-Grid assignments may be searched with relation to a specific group of objects and a specific distance function. An example of, by using a greedy algorithm as follows:

```
let FAILCOUNT = 0.
initialize K-Grid CURRENT to random or arbitrary
    starting assignment.
calculate objective function cost and store in
    BESTCOST.
begin loop:
    let CAND = copy of CURRENT.
    apply complex mutation to CAND.
    calculate objective function cost of CAND and
        store in CANDCOST.
    if CANDCOST < BESTCOST then:
        let BESTCOST = CANDCOST.
        let CURRENT = CAND.
        let FAILCOUNT = 0.
    else
        let FAILCOUNT = FAILCOUNT + 1.
    if FAILCOUNT < MAX_ITERATIONS,
        repeat loop.
    else
        end loop.
output CURRENT and BESTCOST
```

The above example pseudo-code describes the loop by which a computer may mutate the K-Grid, then calculate the objective function as described in 4 and compare it to what was in the previous mutation. If the new position of objects in the K-Grid produces an evaluation of the objective function that is lower than the previous one, then the new K-Grid position assignments are kept; they are considered to be “better.” If the new assignments are not considered to be better, they are discarded, and the previous assignments are kept. Then the loop proceeds through another mutation and evaluation of the objective function. In this embodiment there is a limit (MAX-ITERATIONS) on how many times we will go through this loop when the objective function evaluation does not improve, that is, does not drop in value. If the computer reaches the point where new mutations are no longer reducing the number returned by the objective function, then the search stops and the we stop and the “K-Grid run” is complete (i.e., the clustering process is done). The grid assignments may be output as an optimized clustering of the objects.

The value of MAX_ITERATIONS in the above pseudocode may be any desired number, but the larger the number, the more computing resources may be required to arrive at an optimization. At the same time, having a larger value may result in the discovery of optimizations that would not otherwise have been found.

In one embodiment, the search proceeds such that individual nodes or blocks of nodes are allowed to swap anywhere else on the K-Grid. In another embodiment, the block swaps may be limited to swaps between only nearby or adjacent blocks. Yet another embodiment, the search may begin with unrestricted swaps anywhere within the K-Grid, followed gradually by more restricted swaps as the K-Grid focuses upon an optimization.

Examples of K-Grid search herustics are illustrated in FIG. 6, FIG. 7, and FIG. 8. FIG. 6 shows a one-dimensional, unwrapped K-Grid with 5 elements. The first and the second depictions differ in that the two objects on the left side of the K-Grid were swapped with the two on the right. The overall effect of this was to reduce the objective function cost from 24 to 22. This mutation can therefore be interpreted as an optimization. This example shows one kind of mutation. It is not limiting in the type of mutations that may be applied. In one embodiment, mutations may be generated by a random number generator process which can move an arbitrary number of objects to entirely new positions in the grid. In one embodiment, such objects may move in an unrestricted way to any other location in the K-Grid. In other embodiments, objects may be limited to move only a certain distance, which may for example be defined as a Euclidian grid distance, or as a number of hops, etc. FIG. 7 shows an optimum clustering of this group of objects residing in a one-dimensional unwrapped K-Grid. This is the same result shown in the second case of FIG. 5.

FIG. 8 shows a wrapped and unwrapped K-grid both with K=1, the same number of cells, and with the same objects loaded. In the figure, the objects are not labeled and their metadata are also not shown. What is shown is a costing value in each cell. The top portion of the figure shows the unwrapped version, and the bottom shows the wrapped version. The cost for both is the same in this embodiment, although the wrapped topology in the second example would yield a different clustering.

The costing of 24 for the wrapped and unwrapped cases assumes that the parameter γ of Eq. 6 is 1. Changing γ to be greater than 1 may affect the calculation of distance. For example, setting γ to 2 in Eq. 6 may produce a cost in this embodiment of 17 for the top (nonwrapped) case, and 15.3 for the bottom (wrapped) case.

During the course of a K-Grid search, the values used for the distance function d when objects interact with an empty neighbor, or when two neighbors interact, determines what may be characterized as the phase behavior of the system. Different values for these parameters may in some embodiments cause objects to clump together like a solid, or to fly apart like a gas. In one example, objects may be characterized as being very (or infinitely) close to or very (or infinitely) distant from adjacent empty nodes. In these cases, the value of d may for example be 0 or some high number, respectively. Two adjacent empty nodes may likewise be characterized as near or distant, depending on the desired phase behavior.

Some amount of sparseness within a K-Grid can improve performance, because it may allow many of the objects in the K-Grid to move around more freely then they would otherwise. An empty node can, in various embodiments, act as a spacer between objects, or it can allow easier rearrangement. In one embodiment, approximately 50% of the nodes in a K-Grid are sparse. In another embodiment, the fraction of empty nodes may be in some range from about one third to about two thirds.

In one embodiment, when an object is compared to an empty object, the distance may be forced to be 0. This may give the K-Grid process an interesting property, in that it may tend to produce smaller clusters as the empty cells are “attracted” to nearby objects. It also may mean there is a limit on how sparse a matrix can be. If a matrix is too sparse, and there are too many empty cells, the cost sum may return zero if the empty nodes interpose themselves between objects, thus isolating them from each other.

A local neighborhood may, in one embodiment, be defined symmetrically with respect to reflection and orientation. In general, and especially in that case, when the global cost of a function of the local neighborhoods is summed, the symmetry of the w weighting function may be significant. If the local neighborhood is symmetric, then all possible reflections, and potentially orientations, can have minimum cost. This may create an instability and difficulty in reading results that are only slightly changed between successive runs or iterations. This may result in a pathological case that may cause the K-Grid to iterate needlessly and therefore “thrash.” For example, imagine a one-dimensional K-Grid with 3 objects, and that the distance function (say, NCD) indicates that the metadata of all 3 of them are 0.5 distance from one another. The K-Grid could iterate for some time juggling these 3 objects and would not be able to improve on their clustering.

One solution is to introduce a bias into the objective function that adds a very small number to the objective function's evaluation of closeness of neighbors. The bias added may be a function of location within the K-Grid. This may have the effect of slightly tilting the K-Grid space so that objects will be slightly more likely to gather at one end of an axis than the other. This can eliminate the thrashing behavior described in the previous paragraph. One embodiment of this solution is as follows:

$$w ( p ) = {\sum }_{i = 1}^{k} \frac{( 100 + {p}_{i} ) ( i + 100 ) ( i + 100 )}{1000000} \qquad Eq . 8$$

This may cause objects to fall to one corner and empty spaces to float to the opposite corner in a solid phase parameter regime. This may stabilize orientation to allow for iterative refinement or successive comparison.

In one embodiment, a K-Grid structure may be used for hierarchical clustering. An entire K-Grid may be considered to be enclosed within a single cell of a larger K-Grid. In such a case, one may establish a method for converting an assignment calculated within a smaller K-Grid into an object suitable for analysis at a greater level. In the case of information objects as files or strings, using NCD as a distance function, one embodiment for such a conversion method is concatenation. A program may in one embodiment iterate through all the possible points in a K-Grid in a natural order, and convert a low-cost assignment into a low-entropy sequence ordering for the entire group of objects. This may then allow a K-Grid to be used to reorder smaller objects into more meaningful sequences that may then be analyzed at greater levels in enclosing K-Grids.

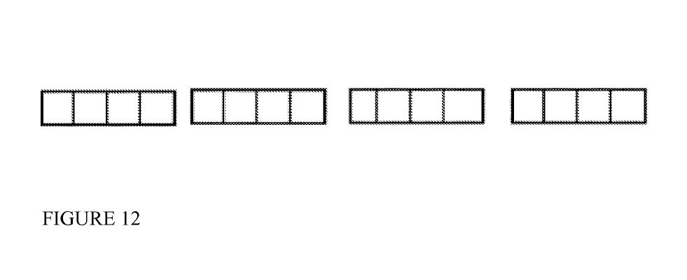

FIG. 12 illustrates an example of such a one-dimensional hierarchical K-Grid. It consists of four K-Grids at the lower level, each consisting of four grid positions which are then gathered together at a second level into a four-position K-Grid at a higher level.

### Further Examples

FIG. 10 is a diagram illustrating a two-dimensional K-Grid based on mitochondrial gene sequences from certain mammals. The K-Grid has 48 cells arranged in 8 rows and 6 columns. The matrix is sparse, as 14 of the 48 cells are empty.

The K-Grid is wrapped in both dimensions. This is shown in the figure by the notations at each black arrow at the end of column or row: by each arrow is shown a label indicating that the item at the end of that row is wrapped to its counterpart at the other end of the row. For example, at the upper left corner of the grid is a cell marked “SHEEP.” Looking at the arrow that points out to the left, that arrow is labeled “Far Right(Rat).” The upper right cell is marked “RAT.” So the notation at the SHEEP cell is referring to its connection or “wrap” to the RAT cell. Along the cells at the edge of the grid, the notation by each arrow indicates that each edge cell is wrapped to the cell at the other end of its row or column.

In this example, the cost calculated by the Objective Function for the illustrated configuration of objects is 84.4041. This cost may be determined by applying the NCD function to a set of metadata of each of the objects/animals in the K-Grid. The metadata for these objects (not shown) may consist of the mitochondrial gene sequence for each of the shown animals, each of which is in several databases accessible to researchers. The distance between each “animal” according to the current layout of animals on the grid may be calculated using NCD (see Eq. 5) and, in one embodiment, using the zlib algorithm as the compressor. One of skill in the art will understand based on the present disclosure how to apply NCD to strings of genetic information in this way. Using these distances, the local cost may in this embodiment be calculated using Eq. 6, and the costs may be summed according to Eq. 7.

FIG. 11 is a diagram, similar to FIG. 10, showing a resulting assignment after several iterations of a cost reducing optimization algorithm. By using NCD as the distance function, it is not necessary to specify any biological information other than non-interpreted gene sequences.

As in FIG. 10, the objects represent animals, and each animal/object has associated metadata that consists of the gene sequence of that animal. In this case, the K-grid has just 40 items, just 6 of which happen to be empty. This K-Grid is also wrapped in two dimensions as can be seen by the labels on each of the arrows at the edge of the grid each of which references the object at the other end of the row or column.

The K-grid illustrates the result of optimization as described above, where the summed cost is calculated to be 35.1716. As can be seen, the K-Grid exhibits greater clustering in FIG. 11 than in FIG. 10. For example, the horse and the donkey, closely related animals, are adjacent to one another. Likewise, the chimp and pygmy chimp are adjacent, and all the primates are together in one region of the K-Grid. Other closely-related animals are adjacent to each other, and the animals have generally been clustered according to genetic similarity. In addition, all the empty nodes have moved together in a contiguous region.

Exemplary embodiments have been described with reference to specific configurations. The foregoing description of specific embodiments and examples have been presented for the purpose of illustration and description only, and although the invention has been illustrated by certain of the preceding examples, it is not to be construed as being limited thereby.

What is claimed is:

1. A method for making a special-purpose digital computer system by storing an executable application program in a memory of a general purpose digital computer system, and executing the stored program to impart to the general purpose computer system the functionality of clustering together information objects having metatata, by changing the state of a one or more processors within the computer system when program instructions are executed, wherein the program instructions comprise:
(a) creating a k-dimensional grid structure;
(b) populating at least some of the nodes of the k-dimensional grid structure with the objects, organized according to arrangement 0;
(c) solving a cost function C₀ for the objects at the nodes of the k-dimensional grid;
(d) rearranging the objects within the k-dimensional grid, such that they are organized according to arrangement 1;
(e) re-computing the cost function C₁ based on the rearranged objects; and
(f) repeating steps (d) and (e) some number of times n≧0;
wherein cost function Cₙ₊₁ is lower than C₀.

2. The method of claim 1, wherein k is between 2 and 4.

3. The method of claim 1, wherein k is 4.

4. The method of claim 1, wherein the cost function C is defined as:
$$C = {\sum }_{r ∈ U} c ( r ) w ( r )$$
where r is a location within the k-dimensional grid, U is the set of all locations within the k-dimensional grid, c(r) is a local cost function for each location r, and w(r) is a weighting function for each location r which may be a constant 1.

5. The method of claim 4, wherein w(r) is defined as:
$$w ( p ) = {\sum }_{i = 1}^{k} \frac{( a + {p}_{i} ) ( i + b ) ( i + c )}{abc}$$
where pᵢ is the i-th coordinate of p., where a, b, and c are constants.

6. The method of claim 5, wherein a, b, and c are each about 100.

7. The method of claim 1, wherein between about one third and two thirdsof the k-dimensional nodes are populated with the objects, and the remainder are empty.

8. The method of claim 7, wherein about half of the k-dimensional nodes are populated with objects, and the remainder are empty.

9. The method of claim 4, wherein w(r) is a weighting function that is asymmetrical in each of k dimensions.

10. The method of claim 4, wherein c(p) is defined as:
$$c ( p ) = {( {\sum }_{q ∈ L ( p )} \frac{{d ( {A}^{- 1} ( q ) , {A}^{- 1} ( p ) )}^{γ}}{‖ q - p ‖} )}^{1 / γ}$$
where q is a location within the k-dimensional grid, L(p) is a local neighborhood of a point p, A⁻¹ is an assignment function mapping a position on the k-dimensional grid to a set of metadata associated with an information object, d(x,y) is a distance function between metadata sets x and y, each of x and y being associated with objects assigned to locations on the k-dimensional grid, and wherein γ is an arbitrary positive parameter.

11. The method of claim 10, wherein γ is within a range from about 1 to about 2.

12. The method of claim 10, wherein d(x,y) is the Normalized Compression Distance between x and y based on a compressor Z.

13. The method of claim 12, wherein Z is the zlib algorithm.

14. The method of claim 10, wherein d(x,y) is the Normalized Web Distance between x and y.

15. A digital device comprising the special purpose digital computer system made by the process of claim 1.
